(19) United States
(12) Patent Application Publication
(10) Pub. No.: US 2005/0136181 A1
(43) Pub. Date: Jun. 23, 2005

(54) Method of dispersing and coating additive on dielectric ceramic powder

(76) Inventors: Han Seong Jung, Suwon (KR); Kang Heon Hur, Suwon (KR); Woo Sup Kim, Sungnam (KR); Byung Doo Moon, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/849,236

(22) Filed: May 20, 2004

(30) Foreign Application Priority Data
Dec. 22, 2003 (KR) 2003-94873

(51) Int. Cl. B05D 7/00

(52) U.S. Cl. 427/221

(57) ABSTRACT

Disclosed is a method of uniformly dispersing and coating an additive on ceramic powder. The method includes adding ethenylbenzene into at least one aqueous solution or at least one sol of metal salt selected from a group consisting of nitrate, acetate, oxide, and carbonate of Mg, Y, Dy, Mn, Ba, and Ca, and adding (Ba₍₁₋ₓ₎Caₓ)TiO₃ ceramic powder (0≦x≦0.05) into a resulting solution or sol to preliminarily mix a resulting mixture, deagglomerating and mixing the preliminarily mixed mixture using a Beads Mill, spray drying the deagglomerated and mixed mixture, and calcining the dried mixture at 400 to 700° C. According to the method, an additive is uniformly coated and dispersed on dielectric ceramic powder, thus the sintering of fine particles constituting the ceramic powder is desirably controlled, and dispersibility of the additive on the ceramic powder is improved.

### CROSS-REFERENCE TO RELATED APPLICATION

This application claims to benefit of Korea Patent application No.2003-94873, filed 22 Dec. 2003 in the Korea Intellectual Property Office, and the disclosure of which is incorporated herein by reference.

### BACKGROUND OF THE INVENTION

1. Field of the Invention

The present invention pertains, in general, to a method of uniformly dispersing and coating an additive on dielectric ceramic powder and, more particularly, to a method of uniformly dispersing and coating an additive on dielectric ceramic powder to produce a ultra-small, ultra-slim, and highly reliable laminated ceramic condenser with ultrahigh capacity.

2. Description of the Related Art

The great advance in the electric and electronic device industry creates a new value through the downsizing of high performance devices. Accordingly, there is a need to develop small-sized and low-priced electronic parts with high performance. Particularly, because of the expectation for the advance of high speed CPU (central processing unit) and small-sized, digitalized, light devices with high performance, demands for a small-sized, slim laminated ceramic condenser having high performance, low impedance at a high frequency range, and excellent heat resistance and reliability are growing.

Additionally, ceramic dielectric layers constituting the laminated ceramic condenser must be slim in order to produce the small-sized laminated ceramic condenser with ultrahigh capacity. Hence, ceramic powder used in the laminated ceramic condenser must have a small particle size and a uniform particle size distribution, and a relatively large specific surface area. In this respect, the uniform dispersion of an additive on the dielectric ceramic powder plays an essential role in controlling the sintering behavior of the fine dielectric ceramic powder, in detail, the sintering window of the dielectric ceramic powder.

For example, in order to satisfy characteristics of an X5R laminated ceramic condenser using dielectric BaTiO₃ mother powder, the additive must be added into the dielectric ceramic powder in a predetermined amount and then sintered.

Conventionally, the additive has been mostly mixed with the dielectric powder according to a solid phase process.

According to the solid phase process, the additive is added in a form of oxide onto the dielectric powder such as BaTiO₃, and then mixed with an organic solvent and a binder using a Beads Mill.

In this regard, the additive must be used in a fine powder form so as to uniformly mix the additive with the dielectric powder, and must be mixed with the dielectric powder for a relatively long time using the Beads Mill. However, the solid phase process is disadvantageous in that the mixing of the additive with the dielectric powder under a severe condition leads the occurrence of a large amount of fine powder, causing the abnormal particle growth of a mixture of the additive and dielectric powder while the mixture is sintered.

Additionally, the solid phase process is mostly used to produce a dielectric composition applied to a relatively thick sheet. Thus, in accordance with the recent trend of increased demands for a slim dielectric layer, it is difficult to apply the solid phase process to a ceramic condenser in which the additive is uniformly dispersed in the slim dielectric layer.

To avoid the disadvantages of the solid phase process, a liquid phase precipitation process is suggested, as disclosed in Japanese Pat. Laid-Open Publication No. 2000-173854, in which ionic metal components are chemically bonded to a surface of ceramic powder using water-soluble salts of metals.

According to the liquid phase precipitation process, the dielectric ceramic powder is dispersed in an aqueous solution of metal salt to produce a slurry, precipitates are formed by controlling pH of the slurry, the resulting slurry is filtered, and a solvent is evaporated from the filtered slurry, thereby accomplishing the dielectric ceramic powder including the metal components chemically bonded to the surface of the ceramic powder.

However, the liquid phase precipitation process is disadvantageous in that the precipitates may be not uniformly formed in throughout the slurry in conformity to a reaction condition, and a portion of the additive is easily segregated. Other disadvantages are that the liquid phase precipitation process requires an additional cleaning process, and anions contained in the aqueous solution of the metal salt remain as an impurity on the ceramic powder when the solvent is evaporated.

At this time, in the liquid phase precipitation process, a dielectric composition, including 100 mol BaTiO₃ acting as a main component, and 0.1 to 0.3 mol Mn, 1.0 to 2.0 mol Dy, 0.3 to 1.0 mol Mg, 0.5 to 1.5 mol Ca, and 1.0 to 2.5 mol Si acting as a side component, is used as a representative dielectric composition satisfying an X7R(X5R) characteristic standard (EIA).

Meanwhile, with respect to the production of a sintered body with a uniform composition, there is suggested a process in which metal nitrate is mixed with an additive, and calcined at relatively high temperatures to form a crystalline phase, as recited in Japanese Pat. Laid-Open Publication No. Sho 64-61354.

However, the above patent application relates to the production of powder acting as a maim component, and describes the formation of the new crystalline phase, but does not disclose the uniform dispersion and adsorption of a small amount of additive onto dielectric powder.

### SUMMARY OF THE INVENTION

Accordingly, the present invention has been made keeping in mind the above problems occurring in the prior art, and an object of the present invention is to provide a method of uniformly dispersing and coating an additive on dielectric ceramic powder.

It is another object of the present invention to provide a method of uniformly dispersing and coating an additive on dielectric ceramic powder so as to effectively control the particle growth and sintering behavior of the dielectric ceramic powder with a relatively large specific surface area.

It is a further object of the present invention to provide a method of uniformly dispersing and coating an additive on dielectric ceramic powder, thereby producing a ultra-small, ultra-slim, highly reliable laminated ceramic condenser with ultrahigh capacity, which satisfies an X5R temperature characteristic capacitance (ΔC is within ±5% at −55 to 85° C.) in conformity to an EIA standard.

Additional objects and/or advantages of the invention will be set forth in part in the description which follows and, in part, will be obvious from the description, or may be learned by practice of the invention.

The above and/or other objects are achieved by providing a method of uniformly dispersing and coating an additive on dielectric ceramic powder, including adding an ethenylbenzene dispersing agent into at least one aqueous solution or at least one sol of metal salt selected from a group consisting of nitrate, acetate, oxide, and carbonate of Mg, Y, Dy, Mn, Ba, and Ca, and then adding (Ba₍₁₋ₓ₎Caₓ)TiO₃ dielectric powder (0≦x≦0.05) into the dispersing agent added solution or sol to preliminarily mix a resulting mixture; deagglomerating and mixing the preliminarily mixed mixture using a Beads Mill; spray drying the deagglomerated and mixed mixture; and calcining the dried mixture at 400 to 700° C.

### BRIEF DESCRIPTION OF THE DRAWINGS

This and other objects and advantages of the invention will become apparent and more readily appreciated from the following description of the preferred embodiments, taken in conjunction with the accompanying drawing of which:

FIG. 1 is a flow chart schematically illustrating a method of uniformly dispersing and coating metal components on dielectric powder according to the present invention; and

FIG. 2 is a flow chart illustrating the production of a laminated ceramic condenser according to the Examples.

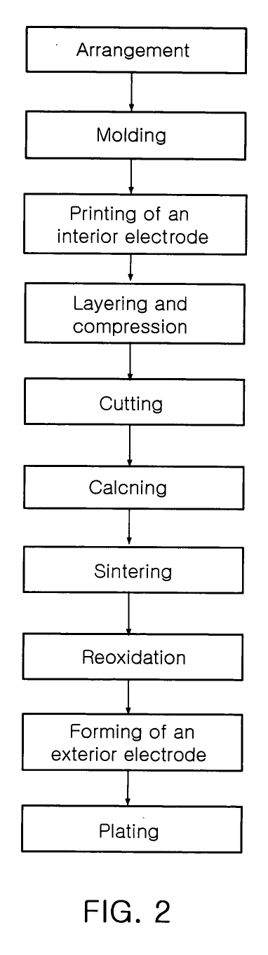

### DETAILED DESCRIPTION OF THE PREFERRED EMBODIMENTS

Reference will now be made in detail to the present preferred embodiments of the present invention, examples of which are illustrated in the accompanying drawings.

According to the present invention, dielectric ceramic powder (hereinafter, referred to as ‘ceramic powder’) and metal salts are uniformly mixed with each other using an additive in a form of water-soluble metal salt and a water-based dispersing agent, and are subjected to a spray drying process, thereby the metal salts are uniformly adsorbed and dispersed onto the ceramic powder.

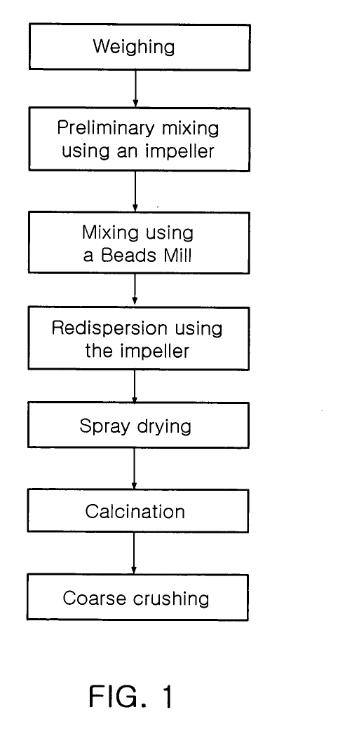

In other words, the uniform dispersion of the metal additive on the ceramic powder is secured by dispersing and coating metal components on the ceramic powder. According to the present invention, when the ceramic powder on which the additive is uniformly dispersed is sintered, the sintering behavior and particle growth of the ceramic powder are effectively controlled, and laminated ceramic condenser with excellent reliability are ensured. With reference to FIG. 1, there is shown a flow chart schematically illustrating a method of uniformly dispersing and coating the metal components on the dielectric powder according to the present invention.

In the present invention, the metal components are mixed, in a form of an aqueous solution or a sol of metal salt, with the ceramic powder.

At least one metal component selected from the group consisting of Mg, Y, Dy, Mn, Ba, and Ca may be added into the ceramic powder to improve properties of the ceramic powder.

In detail, an aqueous solution or a sol of nitrate, acetate, carbonate, and oxide of Mg, Y, Dy, Mn, Ba, and Ca may be mixed with the ceramic powder.

At this time, the water-soluble metal salt is well mixed with the ceramic powder without precipitation or agglomeration. Furthermore, the metal salt is uniformly dispersed on the ceramic powder, and is subjected to a spray drying process, thereby the metal components acting of the additives are adsorbed in the ceramic powder.

In the present invention, it is not necessary to use an organic solvent such as alcohol because of use of the water-soluble metal salt, thus the explosion may be avoided when a mixture of the metal salt and the ceramic powder is subjected to a spray drying process.

The water-soluble metal salt, to be added into the ceramic powder, is dissolved in distilled water, and the water-based dispersing agent and ceramic powder are preliminarily mixed with an aqueous solution of the metal salt. At this time, after the water-based dispersing agent is added into the aqueous solution of the metal salt, the ceramic powder is added into the aqueous solution. Alternatively, the sol of the water-soluble metal salt may be used as well.

The dispersing agent used to disperse the ceramic powder and metal salt in the distilled water may be exemplified by an ethenylbenzene water-based dispersing agent capable of desirably dispersing the ceramic powder and metal salt in water without precipitation of metal ions in water. But, an acrylate-based dispersing agent such as polyammonium acrylate must not be used because it reacts with the metal ions contained in the aqueous solution to form precipitates.

As described above, the additive and ceramic powder are uniformly mixed with and dispersed in water without agglomeration and precipitation because of use of the water-soluble metal salt and water-based dispersing agent.

An amount of the water-based dispersing agent added into the aqueous solution is not limited, but is preferably added into the aqueous solution in an amount required to sufficiently disperse the ceramic powder and metal salt in the aqueous solution.

A pre-mixing process may be conducted using any mixing device such as an impeller. In this regard, the pre-mixing process contributes to uniformly dispersing the metal salt and ceramic powder in the aqueous solution.

Mixing conditions during the pre-mixing process depend on a size of a vessel, and are determined such that the ceramic powder and metal salt are uniformly dispersed in the aqueous solution.

The ceramic powder is exemplified by (Ba₍₁₋ₓ₎Caₓ)TiO₃ (0≦x≦0.05).

It is preferable that the ceramic powder has a particle size of 0.1 to 0.5 μm and a relatively uniform particle size distribution, and is not easily agglomerated. When the particle size of the ceramic powder is less than 0.1 μm, the ceramic powder is significantly agglomerated, thus negatively affecting subsequent processes. On the other hand, when the particle size of the ceramic powder is more than 0.5 μm, the ceramic powder can be uniformly dispersed in the aqueous solution through a conventional mixing process. Thus, the present invention is usefully applied to the ceramic powder with the particle size of 0.1 to 0.5 μm.

A detailed description will be given of the mixing of the metal components with the ceramic powder. Amounts of the metal components contained in the resulting mixture are based on 100 mol (Ba₍₁₋ₓ₎Caₓ)TiO₃ (0≦x≦0.05).

Mg is added into the ceramic powder in an amount of 0.1 to 2.0 mol to provide reduction resistance and suppress particle growth of the ceramic powder. When the amount of Mg is less than 0.1 mol, the particle growth is not suitably controlled, but when the amount is more than 2.0 mol, a sintering process is undesirably conducted because of an increased sintering temperature.

Y is added into the ceramic powder in an amount of 0.1 to 4.0 mol to control oxygen vacancies of the ceramic powder. When the amount of Y is less than 0.1 mol, the oxygen vacancies are not suitably controlled, but when the amount is more than 4.0 mol, reliability of the laminated ceramic condenser is reduced because of an excess donor and the segregation of Y from the ceramic powder.

Dy is added into the ceramic powder in an amount of 0.1 to 2.0 mol to control the oxygen vacancies of the ceramic powder. When the amount of Dy is less than 0.1 mol, the oxygen vacancies are not suitably controlled, but when the amount is more than 2.0 mol, the reliability of the laminated ceramic condenser is reduced because of the excess donor and segregation of Dy from the ceramic powder.

Mn is added into the ceramic powder in an amount of 0.1 to 0.5 mol to provide reduction resistance to the ceramic powder. When the amount of Mn is less than 0.1 mol, the reduction resistance is not provided to the ceramic powder, but when the amount is more than 0.5 mol, the reliability of the laminated ceramic condenser is degraded.

Ba is added into the ceramic powder in an amount of 0.1 to 2.0 mol to control the particle growth of the ceramic powder. When the amount of Ba is less than 0.1 mol, the particle growth of the ceramic powder is not effectively controlled, but when the amount is more than 2.0 mol, the sintering process is undesirably conducted.

Ca is added into the ceramic powder in an amount of 0.01 to 0.5 mol to provide the reduction resistance to the ceramic powder. When the amount of Ca is less than 0.01 mol, the reduction resistance is not provided to the ceramic powder, but when the amount is more than 0.5 mol, the sintering process is undesirably conducted.

Cr and V are additionally added into the ceramic powder in an amount of up to 0.2 mol and up to 0.1 mol, respectively, in conjunction with Y and Dy to auxiliary control the oxygen vacancies of the ceramic powder, if necessary. When the amount of Cr is more than 0.2 mol, the reliability of the laminated ceramic condenser is reduced, and when the amount of V is more than 0.1 mol, V is easily segregated from the ceramic powder, causing the degradation of the reliability of the laminated ceramic condenser.

A preliminarily mixed substance including the ceramic powder and additive is deagglomerated and mixed using a Beads Mill, thus the ceramic powder is physically deagglomerated and dispersed, thereby the metal components are more uniformly dispersed on a surface of the ceramic powder. The preliminarily mixed substance is passed three to five times through the Beads Mill under the condition that ceramic powder will not crushed.

In detail, the preliminarily mixed substance is deagglomerated and mixed using the Beads Mill such that the particle sizes of coarse particles (D99) are 1 μm or lower while fine particles of D10 are not reduced in terms of size.

The deagglomerating and mixing of the preliminarily mixed substance using the Beads Mill are conducted in such a way that the ceramic powder is sufficiently deagglomerated, and that the ceramic powder and additive are sufficiently dispersed.

After the deagglomerating and mixing, if necessary, the mixed substance may be re-dispersed using any mixing device such as an impeller. The re-dispersing is conducted under general dispersion conditions.

After the preliminarily mixed substance is deagglomerated and dispersed, or additionally re-dispersed, the resulting substance is subjected to the spray drying process to adsorb the metal components onto the ceramic powder. The resulting substance is preferably agitated while the spray drying process is conducted, so as to prevent the formation of the precipitates.

In this regard, the resulting substance should be agitated so that an upper part and a lower part of the substance are well mixed with each other. For example, the resulting substance may be subjected to the spray drying process while it is continuously agitated using an impeller tank.

Furthermore, it is preferable that an inner wall of a spray drier is made of stainless steel enduring weak acid so that the mixing of impurities with a water-based slurry due to the corrosion of the spray drier is prevented while the water-based slurry is dried.

As well, an inlet of the spray drier is maintained at 170 to 250° C., and an outlet of the spray drier is maintained at 100 to 150° C. When a temperature of the inlet of the spray drier is less than 170° C., the water-based slurry is not sufficiently dried and a portion of the water-based slurry is adsorbed into a wall of the spray drier. Furthermore, when a temperature of the outlet of the spray drier is less than 100° C., the resulting powder is insufficiently dried. Further, when temperatures of the inlet and outlet of the spray drier are more than 250 and 150° C., respectively, the spray drier is overstrained.

Additionally, it is preferable that a rotation number of a spraying part of the spray drier is within a range from 5,000 to 10,000 rpm. The reason for this is that the slurry is desirably sprayed within the above range to form sticky liquid. Furthermore, the slurry is preferably sprayed as fast as possible to prevent the losing of the slurry as long as the spray drier is not overstrained. Throughout the spray drying process, the metal components contained in the additive are adsorbed in the ceramic powder.

The dried ceramic powder is calcined at 400 to 700° C. For example, when the dried ceramic powder is calcined at lower temperatures than 400° C., it is difficult to remove organics from the metal salt. When the dried ceramic powder is calcined at higher temperatures than 700° C., the ceramic powder are significantly agglomerated, thus negatively affecting subsequent processes.

Organics of anion groups of the metal salt acting as the additive are decomposed and removed by the calcination process. The calcined ceramic powder is subjected to a coarse crushing process, thereby the agglomerated ceramic powder is milled. For example, the calcined ceramic powder is subjected to the coarse crushing process using a hammer mill.

Throughout the above description, the dielectric ceramic powder on which the metal components are uniformly dispersed and coated is accomplished.

According to the present invention, the water-soluble metal salt and dispersing agent are used to disperse and coat the metal components on the ceramic powder. Thus, there is no need to separate a rinsing process and a process of forming the precipitate by controlling pH of a mixture of the ceramic powder and additive.

According to the present invention, the metal components are uniformly dispersed and coated on the ceramic powder, because the mixture of the ceramic powder and additive is subjected to the spray drying process in a dispersed slurry state without forming the precipitate, thereby the segregation of the metal components from the ceramic power does not occur.

The ceramic powder including the additive uniformly dispersed thereon has relatively high dispersibility, and is sintered to produce the resulting sintered body. From a dielectric property evaluation of the sintered body thusly produced, it can be seen that the resulting sintered body has a relatively wider sintering window, thus the sintering behavior and particle growth of the sintered ceramic powder are effectively controlled. Additionally, an accelerated life of the laminated ceramic condenser produced using the sintered body according to the present invention is improved, and preferably improved to 950 min or more than 950 min, thereby the reliability of the laminated ceramic condenser is improved.

In detail, the ceramic powder according to the present invention contributes to realizing an X7R and X5R products with a 1005 size of 3 μm or less in active casting layer thickness and a relatively high capacity of 1 μF.

The present invention may be applied to disperse and coat any other additives on some materials in various fields.

A better understanding of the present invention may be obtained in light of the following example which is set forth to illustrate, but is not to be construed to limit the present invention.

### EXAMPLES 1 to 3

### Solid Phase Mixing Process

Additives including MgCO₃, Y₂O₃, Mn₃O₄, Cr₂O₃, SiO₂, and BaCO₃ were added into 10 λ ball jar, in amounts as described in Table 1, and mixed with each other using a ball mill for 24 hours. At this time, the amounts of the additives are based on 100 mol ceramic powder. The resulting mixture was dried in an oven at 120° C. for 24 hours, milled using a hammer mill, and then filtered using a 60 mesh sieve to remove coarse particles from the mixture.

The filtered mixture including metal oxides was mixed with (Ba_{0.7}Ca_{0.3})TiO₃ (hereinafter, referred to as ‘BT powder’) with a particle size of 0.2 μm in a mixing ratio as described in Table 1 to produce ceramic powder compositions of examples 1 to 3.

Each ceramic powder composition was mixed with 10 wt % polyvinyl butyral binder, and 90 wt % solvent including toluene and ethanol mixed with each other in a mixing weight ratio of 1:1, on the basis of a weight of each ceramic powder composition, thereby producing a thin layer with a thickness of 2.8 μm in a molding device.

An interior electrode was printed using a Ni paste in a size of 2.0×1.2 mm on the thin layer, and this was repeated to produce a 150 layered-structure. The 150 layered-structure was then pressed using a load of 1000 kgf. The pressed structure was cut in a size of 2.0×1.2 mm, calcined at 400° C., sintered at 1240° C., and re-oxidized at 1000° C. An exterior electrode was then manufactured using Cu, and plated using tin to accomplish a laminated ceramic condenser chip with a 2012 size and 150 L.

### EXAMPLES 4 to 13

### Use of Nitrate

BaTiO₃ powder was mixed with a plurality of different metal nitrates as an additive so that each metal component was contained in a mixture of the BaTiO₃ powder and additive in an amount as described in Table 1 to produce dielectric ceramic compositions according to examples 4 to 13. At this time, the amount of each metal component was based on 100 mol BaTiO₃.

In detail, Mg(NO₃)₂.6H₂O, Ba(NO₃)₂, Mn(NO₃)₂.6H₂O, Cr(NO₃)₃.9H₂O, and Y(NO₃)₃.6H₂O were dissolved in DI water such that each metal component was contained in the amount as described in Table 1. At this time, the amount of the metal component was based on 100 mol BaTiO₃. Additionally, 0.3 wt % ethenylbenzene water-based dispersing agent was added to each ceramic composition based on a weight of each ceramic composition.

The resulting solution was poured into an agitating vessel in which (Ba_{0.7}Ca_{0.3})TiO₃ powder with a particle size of 0.2 μm is already stuffed, and then agitated using an impeller at a rotation speed of 20 rpm for one hour to produce slurry. The slurry was milled using a Beads Mill (ball amount: 50%, discharge: 400 kg/h, main rotation speed: 500 rpm) by passing three times, and then agitated in an agitating tank using the impeller at a rotation speed of 20 rpm for one hour.

The milled slurry was subjected to a spray drying process using a spray drier at a rotation of 6000 rpm, and calcined at 450° C. At this time, an inlet and an outlet temperature of the spray drier were 220° C. and 110° C., respectively. The slurry was continuously agitated using the impeller with 22 rpm during the spray drying process. The calcined slurry powder was subjected to a coarse crushing process using a hammer mill.

The crushed powder was mixed with a polyvinyl butyral binder, a solvent including toluene and ethanol mixed with each other in a mixing weight ratio of 1:1, and SiO₂ to form a thin layer with a thickness of 2.8 μm using a molding device like the cases of examples 1 to 3. A laminated ceramic condenser chip with a 2012 size and 150 L was accomplished using the thin layer through the same procedure as examples 1 to 3.

10 wt % binder and 90 wt % solvent were used, based on a weight of the ceramic powder composition, and SiO₂ was added to the ceramic powder composition such that Si was contained in an amount as described in Table 1. The amount of Si was based on 100 mol ceramic powder.

A capacity, a dissipation failure (DF), a temperature characteristic of capacitance (TCC), and an average accelerated life of the laminated ceramic condenser chip produced using the dielectric ceramic compositions according to examples 1 to 13 were measured, and the results are described in Table 1.

The capacity and DF were measured using an Agilent 4278 at 1 KHz and 1 V, and the TCC was measured using the Agilent 4278 within a temperature range from 55 to 125° C.

Additionally, insulating resistance of the laminated ceramic condenser chip was measured using a 2ST-400B/C-9 manufactured by Micro Co. at 150° C. while a voltage of 12.6 V was applied to the laminated ceramic condenser chip for a relatively long time, thereby the average accelerated life was calculated using the measured insulating resistance.

TABLE 1
(unit: mol %)

| Example | Mg | Y | Mn | Ba | Cr | Si | Cp (μF) | DF (%) | ¹TCC | ²Life |
|---|---|---|---|---|---|---|---|---|---|---|
| 1 | 1.0 | 1.5 | 0.1 | 1.0 | 0.2 | 2.0 | 7.5 | 6.3 | −14.4 | 450 |
| 2 | 1.0 | 1.0 | 0.2 | 1.0 | 0.2 | 2.0 | 8.3 | 7.3 | −14.1 | 360 |
| 3 | 1.0 | 0.5 | 0.3 | 1.0 | 0.2 | 2.0 | 9.2 | 10.2 | −13.6 | 300 |
| 4 | 1.0 | 1.5 | 0.1 | 1.0 | 0.2 | 2.0 | 10.5 | 4.3 | −13.4 | 1156 |
| 5 | 1.0 | 1.5 | 0.1 | 1.0 | 0.2 | 1.0 | 10.2 | 4.5 | −14.2 | 962 |
| 6 | 2.2 | 1.0 | 0.1 | 1.0 | 0.2 | 2.0 | 8.3 | 8.8 | −12.4 | 552 |
| 7 | 1.0 | 1.0 | 0.2 | 0.5 | 0.1 | 1.0 | 9.7 | 5.6 | −14.4 | 1002 |
| 8 | 1.0 | 5.0 | 0.2 | 1.0 | 0.2 | 2.0 | 6.5 | 4.5 | −19.3 | 882 |
| 9 | 1.0 | 1.0 | 0.05 | 1.0 | 0.2 | 2.0 | 10.4 | 4.3 | −16.7 | 667 |
| 10 | 1.0 | 1.0 | 0.7 | 1.0 | 0.2 | 2.0 | 9.6 | 3.4 | −15.6 | 345 |
| 11 | 1.0 | 1.5 | 0.2 | 0.01 | 0.2 | 2.0 | 12.2 | 10.4 | −17.8 | 735 |
| 12 | 1.0 | 1.5 | 0.2 | 3.0 | 0.2 | 2.0 | Not measured | | | |
| 13 | 1.0 | 1.5 | 0.2 | 1.2 | 0.4 | 2.0 | 10.3 | 6.6 | −18.4 | 623 |

¹TCC: TCC at 85° C. (%)
²Life: average accelerated life (min)

From the Table 1, it can be seen that laminated ceramic condenser chips according to examples 1 to 3, in which the additive is mixed with the dielectric ceramic powder through a conventional solid phase process, have poor average acceleration lives, causing the ununiform dispersion of the additive in the ceramic powder to significantly reduce reliability of the laminated ceramic condenser chip.

Additionally, an excess particle growth occurring in examples 11 and 13, the semiconductorization of the laminated ceramic condenser chip due to the poor reduction resistance in example 9, and oxygen vacancies formed in a great number due to excess Mn in example 10 contribute to reducing the reliability of the laminated ceramic condenser chip.

In the cases of examples 6, 8, and 12, the ceramic powder is undesirably sintered at 1240° C., or has insufficient density. Moreover, in example 12, it is impossible to measure electric properties of the laminated ceramic condenser chip.

However, in cases that the additives are used in amounts according to a desired composition range of the present invention like examples 4, 5, and 7, the laminated ceramic condenser chip had excellent electric properties satisfying an EIA X5R standard.

### EXAMPLES 14 to 23

### Use of Acetate

BaTiO₃ powder was mixed with a plurality of different metal acetates as an additive so that each metal component was contained in a mixture of the BaTiO₃ powder and additive in an amount as described in Table 2 to produce dielectric ceramic compositions according to examples 14 to 23. At this time, the amount of each metal component was based on 100 mol BaTiO₃.

In detail, Mg(CH₃COO)₂.4H₂O, Ba(CH₃COO)₂, Mn(CH₃COO)₂.4H₂O, and Y(NO₃)₃.6H₂O were dissolved in DI water such that each metal component was contained in the amount as described in Table 2. At this time, the amount of the metal component was based on 100 mol BaTiO₃. Additionally, 0.3 wt % ethenylbenzene water-based dispersing agent was added to each ceramic composition based on a weight of each ceramic composition.

The resulting solution was poured into an agitating vessel in which (Ba_{0.7}Ca_{0.3})TiO₃ powder with a particle size of 0.2 μm is already stuffed, and then agitated using an impeller at a rotation speed of 20 rpm for one hour to produce slurry. The slurry was milled using a Beads Mill (ball amount: 50%, discharge: 400 kg/h, main rotation speed: 500 rpm) by passing three times, and then agitated in an agitating tank using the impeller at a rotation speed of 20 rpm for one hour.

The milled slurry was subjected to a spray drying process using a spray drier at a rotation of 6000 rpm, and calcined at 450° C. At this time, an inlet and an outlet temperature of the spray drier were 220° C. and 110° C., respectively. The slurry was continuously agitated using the impeller with 22 rpm during the spray drying process. The calcined slurry powder was subjected to a coarse crushing process using a hammer mill.

The crushed powder was mixed with a polyvinyl butyral binder, a solvent including toluene and ethanol mixed with each other in a mixing weight ratio of 1:1, Cr₂O₃, and SiO₂ to form a thin layer with a thickness of 2.8 μm using a molding device like the cases of examples 1 to 3. A laminated ceramic condenser chip with a 2012 size and 150 L was accomplished using the thin layer through the same procedure as examples 1 to 3.

10 wt % binder and 90 wt % solvent were used, based on a weight of the ceramic powder composition, and Cr₂O₃ and SiO₂ were added to the ceramic powder composition such that Cr and Si were contained in amounts as described in Table 2. At this time, the amounts of Cr and Si were based on 100 mol ceramic powder.

A capacity, a DF, a TCC, and an average accelerated life of the laminated ceramic condenser chip produced using the dielectric ceramic compositions according to examples 14 to 23 were measured, and the results are described in Table 2.

The capacity, DF, TCC, and average accelerated life of the laminated ceramic condenser chip were measured in the same manner as the examples 1 to 13.

TABLE 2
(unit: mol %)

| Example | Mg | Y | Mn | Ba | Cr | Si | Cp (μF) | DF (%) | ¹TCC | ²Life |
|---|---|---|---|---|---|---|---|---|---|---|
| 14 | 1.0 | 1.5 | 0.1 | 1.0 | 0.2 | 2.0 | 9.8 | 3.3 | −13.6 | 1170 |
| 15 | 1.0 | 1.5 | 0.1 | 1.0 | 0.2 | 1.0 | 10.2 | 3.6 | −13.2 | 1000 |
| 16 | 2.2 | 1.0 | 0.1 | 1.0 | 0.2 | 2.0 | 8.2 | 8.5 | −12.8 | 423 |
| 17 | 1.0 | 1.0 | 0.2 | 0.5 | 0.1 | 1.0 | 9.7 | 5.2 | −14.8 | 980 |
| 18 | 1.0 | 2.5 | 0.2 | 1.0 | 0.2 | 2.0 | 9.1 | 3.3 | −17.8 | 465 |
| 19 | 1.0 | 1.0 | 0.05 | 1.0 | 0.2 | 2.0 | 10.4 | 4.2 | −16.7 | 670 |
| 20 | 1.0 | 1.0 | 0.7 | 1.0 | 0.2 | 2.0 | 6.6 | 4.4 | −19.2 | 1045 |
| 21 | 1.0 | 1.5 | 0.2 | 0.01 | 0.2 | 2.0 | 12.3 | 10.04 | −17.5 | 716 |
| 22 | 1.0 | 1.5 | 0.2 | 3.0 | 0.2 | 2.0 | Not measured | | | |
| 23 | 1.0 | 1.5 | 0.2 | 1.2 | 0.4 | 2.0 | 10.1 | 6.5 | −17.4 | 632 |

¹TCC: TCC at 85° C. (%)
²Life: average accelerated life (min)

From the Table 2, it can be seen that an excess particle growth occurring in examples 21 and 23, the semiconductorization of the laminated ceramic condenser chip due to the poor reduction resistance in example 19, and oxygen vacancies formed in a great number due to excess Mn in example 20 contribute to reducing the reliability of the laminated ceramic condenser chip.

In the cases of examples 16, 18, and 22, the ceramic powder is undesirably sintered at 1240° C., or has insufficient density. Moreover, in example 22, it is impossible to measure electric properties of the laminated ceramic condenser chip.

However, in cases that the additives are used in amounts according to a desired composition range of the present invention like examples 14, 15, and 17, the laminated ceramic condenser chip has excellent electric properties satisfying an EIA X5R standard.

Furthermore, in case that metal components are adsorbed and coated on the ceramic powder using a metal acetate, the metal components are uniformly dispersed on the ceramic powder, thereby improving the reliability of the laminated ceramic condenser chip.

As apparent from the above description, the present invention is advantageous in that an additive is uniformly coated and dispersed on dielectric ceramic powder according to a liquid phase process, thus the additive is not separated from the ceramic powder, the sintering of fine particles constituting the ceramic powder is desirably controlled, and dispersibility of the additive on the ceramic powder is improved. The additive uniformly dispersed thereon according to the present invention is useful to produce a high capacity laminated ceramic condenser with a 1005 size and a capacity of 1 μF or more, and functions to improve an accelerated life of a laminated ceramic condenser chip, thereby improving reliability of the ceramic condenser chip.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method of uniformly dispersing and coating an additive on dielectric ceramic powder, comprising:
adding an ethenylbenzene dispersing agent into at least one aqueous solution or at least one sol of metal salt selected from a group consisting of nitrate, acetate, oxide, and carbonate of Mg, Y, Dy, Mn, Ba, and Ca, and then adding (Ba₍₁₋ₓ₎Caₓ)TiO₃ dielectric powder (0≦x≦0.05) into the dispersing agent added solution or sol to preliminarily mix a resulting mixture;
deagglomerating and mixing the preliminarily mixed mixture using a Beads Mill;
spray drying the deagglomerated and mixed mixture; and
calcining the dried mixture at 400 to 700° C.

2. The method as set forth in claim 1, wherein the additive is mixed with the dielectric ceramic powder in such a way that 0.1 to 2.0 mol Mg, 0.1 to 4.0 mol Y, 0.1 to 2.0 mol Dy, 0.1 to 0.5 mol Mn, 0.1 to 2.0 mol Ba, or 0.01 to 0.5 mol Ca is mixed with 100 mol dielectric ceramic powder.

3. The method as set forth in claim 1, wherein the dielectric ceramic powder is preliminarily mixed with at least one aqueous solution or at least one sol of the metal salt selected from a group consisting of nitrate, acetate, oxide, and carbonate of Cr and V in such a way that 0.2 or less mol Cr and/or 0.1 or less mol V is preliminarily mixed with 100 mol dielectric ceramic powder.

4. The method as set forth in claim 1, further comprising redispering deagglomerated and mixed mixture after the deagglomerating and mixing.

5. The method as set forth in claim 1, wherein the spray drying is conducted using a spray drier having an inlet temperature of 170 to 250° C. and an outlet temperature of 100 to 150° C.

6. The method as set forth in claim 1, wherein the spray drying is conducted using a spray drier having a spraying unit rotating at 5000 to 10000 rpm.
